(19) United States
(12) Patent Application Publication
(10) Pub. No.: US 2019/0285305 A1
(43) Pub. Date: Sep. 19, 2019

(54) SMARTPHONE AS PERSONAL THERMOSTAT FOR HEATING, VENTILATION, AND AIR CONDITIONING (HVAC) SYSTEM

(71) Applicant: QUALCOMM Incorporated, San Diego, CA (US)

(72) Inventor: Jinesh KUNNATHULLY JAYAKUMAR, Stewartsville, NJ (US)

(21) Appl. No.: 15/919,580

(22) Filed: Mar. 13, 2018

(51) Int. Cl. F24F 11/57; F24F 11/65; F24F 11/64; G05B 15/02

(52) U.S. Cl. CPC F24F 11/57; F24F 11/65; F24F 2110/10; G05B 15/02; F24F 11/64

(57) ABSTRACT

This disclosure provides systems, methods and apparatus, including computer programs encoded on computer storage media for supporting communication between a first device, such as a smartphone, and a second device, such as a smart thermostat associated with a heating, ventilating, and air conditioning (HVAC) system. In one aspect, a smartphone with a temperature sensor can detect a local environment temperature and communicate with the smart thermostat to turn on/off various HVAC modules to adjust the temperature in that local environment. In some implementations, a first smartphone can be used to detect the temperature in a first room and communicate with the smart thermostat to turn on/off various HVAC modules in the first room, and a second smartphone can be used to detect another temperature in a second room and communicate with the smart thermostat to turn on/off various HVAC modules in the second room.

### TECHNICAL FIELD

This disclosure relates generally to communications between electronic devices, and more particularly to communications between a smartphone and a device associating with a heating, ventilation, and air conditioning (HVAC) system.

### DESCRIPTION OF THE RELATED TECHNOLOGY

Advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices. More specifically, wireless communication devices that perform new functions, or that perform functions faster, more efficiently or more reliably are often sought after.

Advances in electronic technology have also resulted in smaller, powerful, and “smarter” wireless communication devices. For example, the market for and adoption of smart thermostats is expected to see substantial growth in the future. Smart thermostats can be used to control a building's heating, ventilation and air conditioning (HVAC) by communicating with the HVAC system. Because smart thermostats are connected to the Internet, users can adjust heating, ventilating and air conditioning settings remotely from other Internet-connected devices. While smart thermostats continue to increase in popularity, it would be desirable to further integrate smart thermostat functionality with existing wireless communication devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method. The method includes detecting, at a first device, a first air temperature in a first area, comparing the detected first air temperature to a first threshold, and instructing a smart thermostat to adjust the first air temperature in the first area based on the first threshold comparison. If the detected first air temperature is above the first threshold, the smart thermostat can be implemented to decrease the first air temperature in the first area, however, if the detected first air temperature is below the first threshold, the smart thermostat can be implemented to increase the first air temperature in the first area.

In some implementations, the first air temperature is detected using a temperature sensor associated with the first device. In some implementations, the first device is one of a smartphone, a mobile device, a laptop computer, a tablet device, a wearable device, an Internet of Things (IoT) device, an Internet of Everything (IoE) device, an IoT hub, or an IoE hub.

In some implementations, the method includes the first device requesting temperature control from the smart thermostat and the first device receiving the temperature control. In some implementations, instructing the smart thermostat to adjust the first air temperature in the first area includes turning on or off one or more of a heating, a ventilating and an air conditioning module of an HVAC system.

In some implementations, the method includes detecting, at a second device, a second air temperature in a second area, comparing the detected second air temperature to a second threshold, and instructing the smart thermostat to adjust the second air temperature in the second area based on the second threshold comparison. In some implementations, the second area is a location different than the first area. In some implementations, the adjusted second air temperature is different than the adjusted first air temperature. In some implementations, the second device is one of a smartphone, a mobile device, a laptop computer, a tablet device, a wearable device, an Internet of Things (IoT) device, an Internet of Everything (IoE) device, an IoT hub, or an IoE hub.

Another innovative aspect of the subject matter described in this disclosure can be implemented in an electronic device for wireless communication, including a temperature sensor, a processor, and a memory in electronic communication with the processor. The electronic device includes instructions stored in the memory and operable, when executed by the processor, to cause the electronic device to detect a first air temperature in a first area, compare the detected first air temperature to a first threshold, and instruct a smart thermostat to adjust the first air temperature in the first area based on the first threshold comparison. If the detected first air temperature is above the first threshold, the smart thermostat can be implemented to decrease the first air temperature in the first area, however, if the detected first air temperature is below the first threshold, the smart thermostat can be implemented to increase the first air temperature in the first area. Additionally, the electronic device can be implemented to perform any of the aspects of the innovative method described above.

In some implementations, the processor is further capable of executing processor-executable instructions to request temperature control from the smart thermostat, and receive the temperature control. In some implementations, instructing the smart thermostat to adjust the first air temperature in the first area includes turning on or off one or more of a heating, a ventilating and an air conditioning module of an HVAC system. In some implementations, the electronic device is one of a smartphone, a mobile device, a laptop computer, a tablet device, a wearable device, an Internet of Things (IoT) device, an Internet of Everything (IoE) device, an IoT hub, or an IoE hub.

In some implementations, the processor is further capable of executing processor-executable instructions to detect a second air temperature in a second area, compare the detected second air temperature to a second threshold, and instruct the smart thermostat to adjust the second air temperature in the second area based on the second threshold comparison. In such implementations, the second area may be in a location different from the first area. Additionally, in such implementations, the adjusted second air temperature may be different than the adjusted first air temperature.

Another innovative aspect of the subject matter described in this disclosure can be implemented in a non-transitory computer-readable medium including processor-executable program code configured to cause a processor of an electronic device to detect a first air temperature in a first area, compare the detected first air temperature to a first threshold, and instruct a smart thermostat to adjust the first air temperature in the first area based on the first threshold comparison. If the detected first air temperature is above the first threshold, the smart thermostat can be implemented to decrease the first air temperature in the first area, however, if the detected first air temperature is below the first threshold, the smart thermostat can be implemented to increase the first air temperature in the first area.

In some implementations, the first air temperature is detected using a temperature sensor associated with the electronic device. In some implementations, the processor is further capable of executing processor-executable program code to cause the electronic device to request temperature control from the smart thermostat, and receive temperature control. In some implementations, instructing the smart thermostat to adjust the first air temperature in the first area includes turning on or off one or more of a heating, a ventilating and an air conditioning module of an HVAC system. In some implementations, the electronic device is one of a smartphone, a mobile device, a laptop computer, a tablet device, a wearable device, an Internet of Things (IoT) device, an Internet of Everything (IoE) device, an IoT hub, or an IoE hub.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a layout of an example smart thermostat system.

FIG. 2 shows an example smartphone with a temperature sensor communicating with a smart thermostat in a home environment.

FIG. 3 shows an example home environment with two smartphones communicating with a smart thermostat.

FIG. 4 shows an example flowchart for requesting and releasing temperature control.

FIG. 5 shows and example method for communicating with an HVAC system.

FIG. 6 shows another example method for communicating with an HVAC system.

FIG. 7 shows an example electronic device capable of serving as a personal thermostat in communication with an HVAC system.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving optical signals or RF signals according to any of the IEEE 16.11 standards, the IEEE 802.11 standards, or the Bluetooth® standards. The described implementations also can be implemented in any device, system or network that is capable of transmitting and receiving RF signals according to any of the following technologies or techniques: code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

The techniques described herein relate to devices methods, systems, and apparatuses supporting communication between a first electronic device, such as a smartphone, and a second electronic device, such as a smart thermostat, in communication with a heating, ventilating, and air conditioning (HVAC) system. Smart thermostats, also known as connected thermostats, or learning thermostats, can be implemented to assume temperature control responsibility, and can be enabled to allow a user to remotely control the temperature of a home or building throughout the day. For example, in preparation of providing a warm sleeping environment, a user can program a smart thermostat to increase the air temperature of a home by turning on the heating module of the HVAC system at 9 pm. Smart thermostats include temperature gauges, or sensors, or both, to detect the air temperature around the smart thermostat's location. As such, the smart thermostat can be programmed to maintain that desired temperature throughout the night, before decreasing the air temperature at 7 am by turning on the air conditioning module of the HVAC system, or by allowing the ventilation module of the HVAC system to open or close. Examples of smart thermostats include Nest®, Ecobee®, Tado®, Lyric® by Honeywell, and Heat Genius®, amongst others. Such smart thermostats are generally accompanied by software applications, or “apps,” which can be installed on a smartphone device from an app store or app marketplace. Over an Internet connection, a user can control the smart thermostat via the app interface to increase or decrease the temperature, increase or decrease the ventilation, or program an operational schedule into the HVAC system.

Despite the increase in popularity of smart thermostats, the commercial solutions available today lack the ability to provide localized temperature experiences. In particular, because the smart thermostat is usually located in only one, or a few rooms of a multi-room home or building, the smart thermostat may not recognize that the temperatures, as well as the heating, ventilation and cooling rates in different rooms may vary. For example, a smart thermostat, set at 72 degrees Fahrenheit (° F.), located on a first floor of a home, may not realize that the temperature on the second floor of the home has increased and now sitting at 75° F., in part due to heat generally rising. In such an example, a person sleeping on the first floor of the home may be feeling a comfortable temperature, but a person sleeping on the second floor of the home may be warmer and potentially uncomfortable in the elevated temperature. In other words, the temperature around and sensed by the smart thermostat may feel different to a user located remotely from where the smart thermostat is located.

According to the disclosed techniques, a smartphone can be implemented as a personal thermostat. Since smartphones have become ubiquitous devices and are carried by the user nearly everywhere within a home or building, instead of purchasing additional smart thermostats to ensure that HVAC system conditions are consistent throughout the home or building, one or more temperature sensors residing within, or on, the smartphone can be used to detect the local temperature and communicate with the smart thermostat to turn on/off various HVAC system modules. In essence, the smartphone can be implemented to take “temperature control” responsibility away from the smart thermostat. The smartphone also can be implemented to instruct the smart thermostat to drive the HVAC system modules in accordance with the smartphone's temperature requests. In some implementations, a first smartphone can be used to detect the local temperature and communicate with the smart thermostat to turn on/off various HVAC system modules in a first room, and a second smartphone can be used to detect another local temperature and communicate with the smart thermostat to turn on/off various HVAC system modules in a second room. In this instance, both the smartphones can be implemented to take responsibility of temperature control away from the smart thermostat and instruct the smart thermostat to drive various HVAC system modules in accordance with both smartphone's temperature demands, with respect to their local area environments.

Particular implementations of the subject matter described in this disclosure can be implemented to realize one or more of the following potential advantages. Utilizing a smartphone as a remote thermostat can enable customized temperature experiences for users throughout a home or building. The portability of a smartphone serving as a remote thermostat can enable individualized temperature settings in particular areas within a home or building. Additionally, by utilizing the smartphone as a remote thermostat, energy efficiency within the home or building may be achieved, and HVAC system-related costs may be decreased. Furthermore, the smartphone can be utilized as a backup thermostat in case the primary thermostat fails.

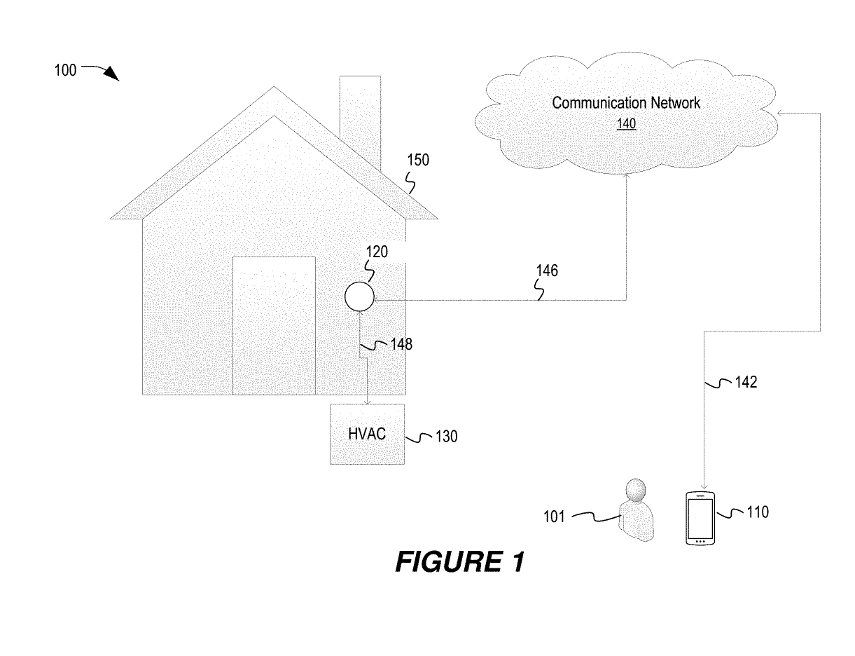

FIG. 1 shows a layout of an example smart thermostat system 100. The smart thermostat system 100 includes an electronic device capable of wireless communications, depicted as a smartphone 110, communicating with a smart thermostat 120, over a wireless communication network 140. The smart thermostat 120 is located within a home 150 and communicatively coupled to an HVAC system 130. The HVAC system 130 is depicted exterior to the home 150, however, a person having ordinary skill in the art will readily recognize that the HVAC system 130 also can be located interior to the home 150.

An electronic device capable of wireless communication also may be referred to as a mobile device, wireless device, a remote device, a handheld device, or a subscriber device, or some other suitable terminology, where the “device” may also be referred to as a unit, a station, a terminal, or a client. While the electronic device depicted is a smartphone 110, the electronic device may be implemented as any computing device configured to receive, process and otherwise handle communications, including audio or visual or audio/visual (i.e., video), over a communications network. The electronic device also may be a cellular phone, a personal digital assistant (PDA), a laptop or laptop computer, a tablet device, a personal computer, a gaming console, a virtual or augmented reality device, a drone, an Internet of Things (IoT) device, or other electronic system. IoT devices also may be referred to as an Internet of Everything (IoE) device, an IoT hub, and IoE hub, or any other physical device, vehicle, or home appliance that is embedded with electronics and network connectivity, which enable these objects to connect and exchange data. The IoT device also may be referred to as a virtual assistant device, such as Amazon Alexa®, Google Home®, etc., a wearable device, such as smart watches, earbuds, headphones, Google Glass®, etc., an in-vehicle entertainment or communication system, a home security system, or any device having an interface, such as a network interface, to a communications network and suitable input and output devices. Wearable devices also may be referred to as wearable technology, wearable gadgets, wearables, or some other suitable terminology, which generally describes electronics and software-based technology that is worn on the body, either as an accessory, or as part of material used in clothing. As depicted, the smartphone 110 is communicatively coupled (shown as line 142) to the communication network 140.

The communication network 140 enables devices to communicate with one another over a communication medium. Examples of protocols that can be used to form communication networks 140 can include, near-field communication (NFC) technology, radio-frequency identification (RFID) technology, Bluetooth, Bluetooth Low Energy (BLE), Zigbee, or Wi-Fi (i.e., Institute of Electrical and Electronics Engineers (IEEE) 802.11) technology, the Internet Protocol (“IP”), Transmission Control Protocol (“TCP”), User Datagram Protocol (“UDP”), device-to-device (D2D) protocols, long-term evolution direct (LTE-D), narrow band Internet of Things (NB-IoT), LTE category M (LTE CAT-M), Vehicle to X (V2X), or other such types of protocols described throughout this disclosure. The smartphone 110 can be implemented to communicate directly or indirectly, such as through a software application, with the smart thermostat 120 using communication protocols provided by one or more of these example communication networks 140.

The smart thermostat 120 is communicatively coupled 146 to the communication network 140. The smart thermostat 120 is also communicatively coupled 148 to the HVAC system 130. In some implementations, the smart thermostat 120 and HVAC system 130 are coupled via electrical wires. In some other implementations, the smart thermostat 120 and HVAC system 130 are coupled via a communication network, such as those described above. The HVAC system 130 includes HVAC system modules, such as heating, ventilation and air conditioning modules, in addition to HVAC system registers, grilles and vents, hereinafter “vents”, as well as the associated piping capable of transporting air throughout the home 150. In the depicted example, the home 150 is a residential house, however, the home 150 can be representative of an office, a building, a duplex, a multifamily unit, a hotel, etc.

In some implementations, the smart thermostat system 100 can be initiated when a user 101, operating a mobile device, such as the smartphone 110, opens an app associated with the smart thermostat 120, or utilizes a web browser to commence communication with the smart thermostat 120 over the communication network 140. The user 101 can set a desired temperature using the app or web browser on the smartphone 110, which is received by the smart thermostat 120. Upon receiving the input setting the temperature, the smart thermostat 120 can be implemented to control the HVAC system 130 to heat, ventilate or cool the home 150 to the desired temperature. In some implementations, the user 101 can program a temperature schedule into the smartphone 110 for the smart thermostat 120 to receive. For example, the temperature schedule may include instructions to turn off all HVAC system 130 operations during the hours of 9 am to 5 pm, while the user 101 is at work. The temperature schedule also may include instructions to turn on the air conditioning operation at 5:01 pm until the temperature of the home 150 reaches a particular temperature, such as 63° F. The temperature schedule may further include instructions to turn on the heating operation at 9:45 pm until the temperature of the home 150 reaches 70° F., thus providing a warm nighttime environment. In some implementations, the smart thermostat 120 will begin to learn the user's 101 desired temperature preferences and will begin to develop a reliable program to automatically adjust the HVAC system 130 according to such preferences. For example, the smart thermostat 120 can be implemented to learn the user's 101 desired temperature preferences for mornings versus evenings, weekdays versus weekends, weekdays versus weekdays, and other such comparative parameters.

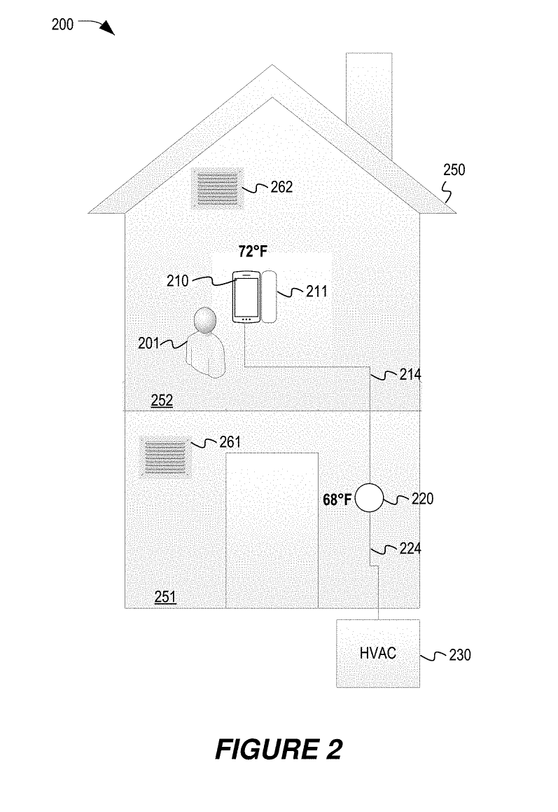

FIG. 2 shows an example smartphone 210 with a temperature sensor 211 communicating with a smart thermostat 220 in a home environment 200. In some implementations, the temperature sensor 211 can be implemented to reside within, or external to, the smartphone 210. The smartphone 210 is communicatively coupled 214 to the smart thermostat 220 over any of the communication networks described in FIG. 1. The smart thermostat 220 is communicatively coupled 224 to an HVAC system 230 via electrical wires or any communication network described in FIG. 1. As depicted in FIG. 2, a user 201 is with the smartphone 210 and located on the second (upstairs) floor 252 of a home 250, while the smart thermostat 220 is located on the first (ground) floor 251 of the home 250. The smart thermostat 220 can be implemented to serve as the “temperature control” unit of the home 250 and can be implemented to instruct the HVAC system 230 to turn on/off various modules. In other words, the temperature sensors or gauges associated with the smart thermostat 220 can detect the temperature around the smart thermostat 220, and once the temperature rises/falls to the desired or set temperature, the smart thermostat 220 can instruct the HVAC system 230 to turn off one or more modules, or turn off completely.

In the depicted example, the smart thermostat 220 is set to 68 F and is controlling the HVAC system 230 to maintain the temperature in the home 250 at 68° F. The user 201 on the second floor feels warmer, in part due to warmer air tending to rise, and per the temperature sensor 211 realizes that the local area temperature on the second floor 252 is at 72° F., which is uncomfortable to the user 201. According to the disclosed techniques, in order to adjust the local area temperature, the smartphone 210 can be implemented to communicate with the smart thermostat 220 to turn on/off one or more HVAC system 230 modules, i.e., heating, ventilating or air conditioning modules, in an effort to adjust the local area temperature in the vicinity of the smartphone 210. In this example, the smartphone 210 can be implemented to request temperature control from the smart thermostat 220, and can then instruct the smart thermostat 220 to turn on the air conditioning (or ventilation) operation of the HVAC system 230 until the local area temperature detected by the temperature sensor 211 is at a comfortable 68° F. on the second floor 252. In other words, the smartphone 210 with a temperature sensor 211 can be implemented to serve as a personal thermostat for controlling the HVAC system 230.

In some implementations, the smartphone 210 can receive data, information, or a notification (hereinafter, an indication) from the temperature sensor 211 that the local area temperature is warmer than the temperature set by the smart thermostat 220, or that the local area temperature has exceeded a threshold or fallen under a threshold. Upon receiving the indication from the temperature sensor 211, the smartphone 210 can be implemented to request temperature control from the smart thermostat 220. Once the smartphone 210 is authenticated, it can be implemented to communicate with the smart thermostat 220, and through the smart thermostat 220, can direct the HVAC system 230 to make temperature adjustments.

In some implementations, the indication received from the temperature sensor 211 can include an audible notification, such as an announcement, an alert, an alarm, etc., a textual notification, such as a pop-up message box, a push message, an email, a text message, flashing letter or words, etc., or a visual notification, such as an image, video clip, or flashing lights, etc., aimed at gaining the user's 201 attention that the local area temperature has exceeded or fallen under a threshold. The threshold, or temperature threshold, can include a particular temperature, or temperature range, programmed into the smartphone 210, such that when the threshold is surpassed/fallen under, the temperature sensor 211 will send the indication to the smartphone 210. In turn, the smartphone 210 can then instruct the smart thermostat 220 to generally increase, or decrease, the temperature, or can instruct the smart thermostat 220 to turn on/off the heating, ventilating or air conditioning modules of the HVAC system 230.

In some implementations, such as where a home 250 includes only a few HVAC system 230 output vents, the smartphone 210 can instruct the HVAC system 230, via the smart thermostat 220, to initiate turning on the air conditioner and commence blowing cooler air throughout each of the vents in the home 250. In such an implementation, the air conditioning module of the HVAC system 230 will remain active until the local area air temperature on the second floor 252 reaches 68° F. as recorded by the temperature sensor 211. Once the temperature sensor 211 detects or senses that the local area air temperature is at the desired temperature, or within an acceptable temperature range, such as +/−1 or 2 degrees Fahrenheit, the temperature sensor 211 can provide an indication to the smartphone 210, which can, in turn, to instruct the smart thermostat 220 to turn off the air conditioning module of the HVAC system 230. In homes, offices, buildings, etc., with very few output vents connected to the HVAC system 230, this described approach may result in wasted energy costs, as the temperature on the second floor 252 may be the desired 68° F., but the temperature on the first floor 251, which is normally governed by the smart thermostat 220, may be colder, such as approximately 64° F., since the temperature control of the smart thermostat 220 was assumed by the smartphone 210 and cold air was blowing throughout the entire home 250. Depending on the user's 201 preferences, or sensitivity to temperature changes, this may be an acceptable solution.

In some other implementations, the smart HVAC system 230 will include individually controllable “smart” vents 261, 262, each with a communication interface, which can receive instructions from one or more of the smartphone 210, the smart thermostat 220, or the HVAC system 230. The communication interface can include technologies such as Bluetooth, Bluetooth Low Energy, Near Field Communications (NFC), radio frequency identification (RFID), 60 GHz Wi-Fi, millimeter wave (mmWave), or other lower power, or lower range, wireless communication technologies. The communication interface includes control mechanisms to open and close each smart vent 261, 262. In some implementations, using proximity determinations, such as signal strength, or indoor GPS, the smartphone 210 may be able to identify the smart vents 261, 262 most proximate to itself, or those smart vents 261, 262 located on the same floor as the smartphone 210. For example, the smartphone 210 may identify the vent most proximate to itself and through the smart thermostat 220 and the HVAC system 230, instructions can be sent to that smart vent 262 to open, allowing for cooler air to be routed solely through that vent 262. Additionally, the smartphone 210 may be able to identify the most proximate vents by identifying the room it is located in. For example, the smartphone 210 can be implemented to communicate with one or more devices in a room, and determine its location within the home 250 based on its proximity to the devices in the room. Once the smartphone 210 has identified the room, such as the room 252, the smartphone 210 can utilize a pre-configured database to look up the nearest vents, such as smart vent 262, to that room. Furthermore, the smartphone 210 may be implemented to detect sounds, or noise, coming from the smart vents 261, 262 and determine which smart vents 261, 262 are most proximate to the smartphone 210. Alternatively, the smart vent's 262 communication interface may send a signal to the smart HVAC system 230 that it is most proximate to the smartphone 210, and the smart HVAC system 230 can instruct the signaling smart vent 262 to open, while the other vents remain closed.

In implementations including a smart HVAC system 230 having multiple individually controllable smart vents 261, 262 throughout the home 250, the smartphone 210 can instruct the HVAC system 230, via the smart thermostat 220, to turn on the air conditioner and blow cooler air through the vents 262 located only on the second floor 252 of the home 250. For example, the smartphone 210 can instruct the smart thermostat 220 to turn on the air conditioning module of the smart HVAC system 230 until the local area air temperature on the second floor 252 reaches 68° F. as recorded by the temperature sensor 211. The smart HVAC system 230 can be implemented to close the smart vents 261 located on the first floor 251, and to open the smart vents 262 located on the second floor 252. The smart HVAC system 230 can then begin air cooling operations through the vents 262 located on the second floor 252 of the home 250. Once the temperature sensor 211 detects or senses that the local area air temperature is at the desired temperature, or within an acceptable temperature range, such as +/−1 or 2 degrees Fahrenheit, the temperature sensor 211 can provide an indication to the smartphone 210 to instruct the smart thermostat 220 to turn off the air conditioning module of the smart HVAC system 230. In this implementation, energy costs will be better preserved, as the temperature on the second floor 252 will be the desired 68° F. as detected by the smartphone 210 temperature sensor 211, and the temperature on the first floor 251 will likely remain at or near 68° F. (+/−1 or 2 degrees Fahrenheit, or another acceptable margin of error) since the cooler air was being pushed only through the second floor 252 smart vents 262.

In some other implementations, the smartphone 210 can be configured to monitor the temperature in particular area without requesting temperature control from the smart thermostat 220. In such an implementation, the smartphone 210 can be configured to send one or more indications to other devices within the home 250. For example, the smartphone 210 can be placed in proximity to a baby's crib and if the temperature in the baby's room exceeds a particular threshold, the smartphone 210 can send an alert to an IoT device located in another room.

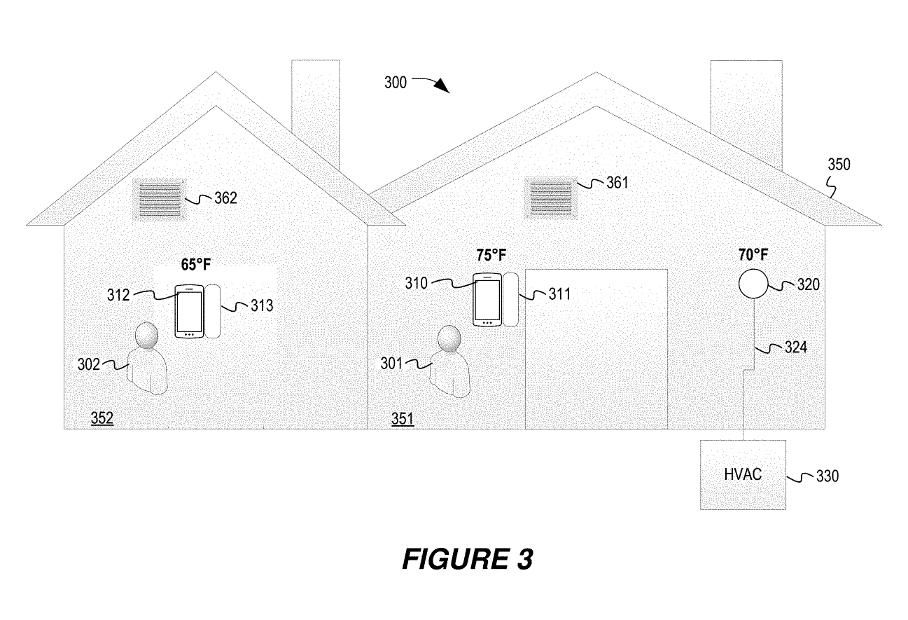

FIG. 3 shows an example home environment 300 with two smartphones 310, 312 communicating with a smart thermostat 320. The smartphones 310, 312 are communicatively coupled to the smart thermostat 320 over any of the communication networks described in FIGS. 1 and 2. The smart thermostat 320 is communicatively coupled 324 to a smart HVAC system 330 via electrical wires or any communication network as described in FIGS. 1 and 2. The smart HVAC system 330 includes individually controllable smart vents 361, 362, or in some implementations, group controllable smart vents, that include communication interfaces. The communication interface can include technologies such as Bluetooth, Bluetooth Low Energy, Near Field Communications (NFC), radio frequency identification (RFID), 60 GHz Wi-Fi, millimeter wave (mmWave), or other lower power, or lower range, wireless communication technologies. The communication interfaces enable the smart vents 361, 362 to receive open/close instructions from the HVAC system 330, as well as from the smart thermostat 320, and in some implementations, the smartphones 310, 312 too. As depicted in FIG. 3, a user 301 is with the smartphone 310 in room 351 of a home 350, and another user 302 is with the smartphone 312 in room 352 of the home 350.

In the depicted example, the smart thermostat 320 is set to 70° F., but the user 301 desires the temperature in room 351 to increase to 75° F., while the user 302 desires the temperature in room 352 to decrease to 65° F. In such an example, the disclosed techniques include mechanisms to increase the local area temperature in room 351 to 75° F. and decrease the local area temperature in room 352 to 65° F. The smartphone 310 includes one or more temperature sensors 311, and the smartphone 312 includes one or more temperature sensors 313. The temperature sensor 311 can be implemented to send an indication to the smartphone 310 whenever the temperature falls below a 75° F. threshold. Upon falling below that threshold, the smartphone 310 can be implemented to communicate with the smart thermostat 320 and instruct the smart thermostat 320 to turn on the heating module of the smart HVAC system 330. The instructions can specify that the smart HVAC system 330 should open smart vents in proximity to the smartphone 310, such as smart vent 361, while keeping other smart vents, such as smart vent 362, closed. In some implementations, using proximity determinations, such as signal strength, or indoor GPS, the smartphone 310 may be able to identify the smart vent 361 most proximate to itself, or the vent located on the same floor as the smartphone 310. For example, the smartphone 310 may identify the smart vent most proximate to itself, and through the smart thermostat 320 and the smart HVAC system 330, instructions can be sent to that smart vent 361 to open, allowing for the requested warmer air to be routed solely through that smart vent 361. Alternatively, the smart vent's 361 communication interface may send a signal to the smart HVAC system 330 that it is most proximate to the smartphone 310, and the smart HVAC system 330 can instruct the signaling smart vent 361 to open, while the other vents, such as smart vent 362, remain closed. Other proximity determination capabilities, such as those described with respect to FIG. 2 also are applicable with respect to FIG. 3.

Additionally, the temperature sensor 313 can be implemented to send an indication to the smartphone 312 whenever the temperature rises above the 65° F. threshold. Upon rising above that threshold, the smartphone 312 can be implemented to communicate with the smart thermostat 320 and instruct the smart thermostat 320 to turn on the air conditioning module of the smart HVAC system 330. The instructions can specify that the smart HVAC system 330 should open smart vents in proximity to the smartphone 312, such as smart vent 362, while keeping other smart vents, such as smart vent 361, closed. Again, in some implementations, using proximity determinations, such as signal strength, or indoor GPS, the smartphone 312 may be able to identify the smart vent 362 most proximate to itself, or the vent located on the same floor as the smartphone 312. For example, the smartphone 312 may identify the smart vent most proximate to itself, and through the smart thermostat 320 and the smart HVAC system 330, instructions can be sent to that smart vent 362 to open, allowing for the requested cooler air to be routed solely through that smart vent 362. Alternatively, the smart vent's 362 communication interface may send a signal to the smart HVAC system 330 that it is most proximate to the smartphone 312, and the smart HVAC system 330 can instruct the signaling smart vent 362 to open, while the other vents, such as smart vent 361, remain closed. Again, other proximity determination capabilities, such as those described with respect to FIG. 2 also are applicable with respect to FIG. 3.

In such an implementation where more than one smartphone 310, 312 is simultaneously requesting the temperature to be increased and decreased in two different rooms, the smart thermostat 320 can instruct the smart HVAC system 330 to intermittently turn on the heating and air conditioning units in a time slicing manner, while the smart vents 361, 362 are only opened during the times the requested HVAC system 330 modules are running. A person having ordinary skill in the art will readily understand that time slicing, or other techniques to implement multitasking, or scheduling, for systems can be applied to this implementation. Once the temperature sensors 311, 313 detect or sense that the local area air temperature is at least at the desired temperature, or within an acceptable temperature range, such as +/−1 or 2 degrees Fahrenheit, the temperature sensors 311, 313 can provide one or more indications to the smartphones 310, 312 to instruct the smart thermostat 320 to turn off the various modules of the smart HVAC system 330. As such, the temperature in room 351 will be at or near the desired 75° F. (+/−1 or 2 degrees Fahrenheit, or another acceptable margin of error) as detected by the smartphone 310 temperature sensor 311 since warmer air was being pushed through the smart vent 361, and the temperature in room 352 will be at or near the desired 65° F. (+/−1 or 2 degrees Fahrenheit, or another acceptable margin of error) as detected by the smartphone 312 temperature sensor 313 since cooler air was being pushed through the smart vent 362.

In some implementations, the smartphone 310 can detect the local air temperature in a first area, such as the room 351, can compare the detected local air temperature of the room 351 to a first temperature threshold, and can instruct the smart thermostat 320 to adjust the local air temperature in the room 351 based on the first temperature threshold comparison. Given the portability of the smartphone 310, additionally, the smartphone 310 can detect the local air temperature in a second area, such as the room 352, can compare the detected local air temperature of the room 352 to a second temperature threshold, and can instruct the smart thermostat 320 to adjust the local air temperature in the room 351 based on the second temperature threshold comparison. In other words, the smartphone 310 can be implemented to serve as a remote thermostat for more than one room in the home 350, and can be implemented adjust the temperature in more than one room in the home 350. In such an example, the temperature in room 351 can be set differently than the temperature in room 352.

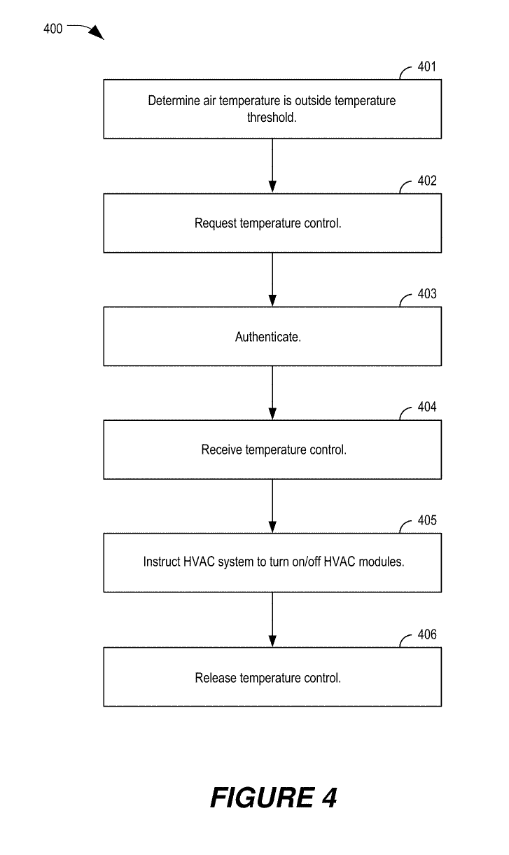

FIG. 4 shows an example flowchart 400 for requesting and releasing temperature control. At block 401, an electronic device, such as any electronic device described with respect to FIGS. 1-3, with the ability to detect localized air temperature, can determine that the localized air temperature is outside, or does not comport with, a temperature threshold. For example, an electronic device with a temperature sensor, such as the smartphones 210, 310 and 312 described in FIGS. 2 and 3, can detect the localized air temperature in an area, such as the ambient air temperature in a room, or the ambient air temperature within a particular radius of the smartphone, such as within a 1 meter (m), 2 m, 3 m or even up to a 10 m radius of the smartphone. The air temperature can be detected using a temperature sensor, such as the temperature sensors 211, 311 and 313 described in FIGS. 2 and 3, or any other sensor or detector suitable for measuring temperature. Upon detecting the air temperature, the smartphone can be implemented to compare the detected temperature to the temperature threshold.

The temperature threshold can be a temperature, or a temperature range, programmed into the memory of a smartphone, or stored in an app available on the smartphone. The temperature threshold may be preprogrammed into the smartphone, such as by a smartphone original equipment manufacturer to ensure the smartphone remains within safe operating conditions, or can be programmed into the smartphone memory, or the app, by a user. The user can program a preferred or desired temperature threshold suitable to the user's particular preferences or needs. In some implementations, multiple temperature thresholds may be programmed into the smartphone. For example, the user may program a maximum temperature preference, such as 78° F., and a minimum temperature preference, such as 58° F., whereby the user desires to remain in a temperature zone between 58° F. and 78° F. Alternatively, in some implementations, the user may program conditional temperature thresholds into the smartphone. For example, the user may program a temperature threshold range for the summer months, such as desiring to remain in a temperature zone between 60° F. and 70° F., and a different temperature threshold range for the winter months, such as desiring to remain in a temperature zone between 68° F. and 75° F. A person having ordinary skill in the art will readily recognize that temperature thresholds may be set for different times of day, different days of the week, different months of the year, etc.

After the smartphone compares the detected air temperature to the temperature threshold, the smartphone can determine if the air temperature is outside the temperature threshold. Determining that the air temperature is outside the temperature threshold includes determining that the air temperature exceeds, or is beyond, a maximum threshold temperature, or a maximum threshold temperature range. Additionally, it includes determining that the air temperature is under, or below, a minimum threshold temperature, or a minimum threshold temperature range. The term “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

At block 402, an electronic device, such as any electronic device described with respect to FIGS. 1-3, can request temperature control. For example, the smartphones 210, 310 and 312 described in FIGS. 2 and 3, can request temperature control from a smart thermostat, such as the smart thermostats 220 and 320 described in FIGS. 2 and 3. The smartphone can be implemented to automatically request temperature control from the smart thermostat upon determining that localized air temperature is outside a particular temperature threshold. In some implementations, an app operating on the smartphone and associated with the smart thermostat can automatically request temperature control from the smart thermostat. For example, a “smart thermostat app” residing on the smartphone can request, via a network or cloud service, temperature control to be handed over from the smart thermostat to the smartphone. Alternatively, a user operating the smartphone can request temperature control from the smart thermostat upon learning that the localized air temperature is outside the temperature threshold, or when the user desires to adjust the temperature in a particular area. In some implementations, the smartphone can automatically request temperature control during a particular time frame, such as between 10 pm and 6 am. For example, a user may desire that the smartphone have responsibility for temperature control when the user is sleeping, and the smartphone is located nearby the user on a nightstand.

At block 403, the requesting electronic device, such as the smartphones 210, 310 and 312 described in FIGS. 2 and 3, can be authenticated. The authentication process can be performed with or by the smart thermostat, such as the smart thermostats 220 and 320 described in FIGS. 2 and 3, or by a network or cloud service associated with the smart thermostat app. In some implementations, authentication can include username and password entries in a user interface, or within the app itself, or by using NFC, or a similar technology, and bringing the smartphones 210, 310 and 312 in relative proximity to the smart thermostats 220 and 320. Once the smartphone has been properly authenticated, temperature control can be transferred from the smart thermostat to the smartphone. In some implementations, the smartphone will receive an indication that it is authorized for temperature control. If the smartphone is not properly authenticated, temperature control will remain with the smart thermostat, and the smartphone may receive an indication that it is not authorized to receive temperature control.

At block 404, the authenticated electronic device, such as the smartphones 210, 310 and 312 described in FIGS. 2 and 3, can receive temperature control from the smart thermostat, such as the smart thermostats 220 and 320 described in FIGS. 2 and 3, over a communication network, such as the communication network 140 described in FIG. 1. Upon relinquishing temperature control, the smart thermostat may be implemented to display a notification that the smartphone is now responsible for temperature control. The smartphone can be implemented to read, or otherwise receive, the current temperature set by the smart thermostat. The current temperature can be provided by the smart thermostat itself via a direct connection with the smartphone, or from a network or cloud service associated with the smart thermostat app. The smart thermostat also can provide the current status of the HVAC system to the smartphone, such as which modules are turned on/off, as well as any delays associated with the HVAC system's operation. In some implementations, such as when the communication network is experiencing delays, malfunctioning, or a power outage, or the smartphone is outside the communication range of the smart thermostat, temperature control can be returned to the smart thermostat. For example, if the smartphone and smart thermostat cannot communicate over the communication network for a period of time, such as 1 minute, 2 minutes, 5 minutes, etc., the smart thermostat can be implemented to automatically retake temperature control.

At block 405, the electronic device with temperature control, such as the smartphones 210, 310 and 312 described in FIGS. 2 and 3, can instruct an HVAC system, such as the HVAC system 230 and 330 described in FIGS. 2 and 3, to turn on or turn off one or more HVAC system modules. The smartphone, via the smart thermostat, can instruct the HVAC system to increase the air temperature, or decrease the air temperature. Additionally, the smartphone, via the smart thermostat, can instruct the HVAC system to turn on/off one or more of the heating module, the ventilation module, or the air conditioning module. In some implementations, such as with a smart HVAC system, the smartphone may be able to directly instruct the smart HVAC system, over a communication network, to increase or decrease the temperature, or turn on/off one or more HVAC modules. In smart HVAC system implementations, the smartphone can instruct the smart thermostat, or the smart HVAC system itself, to only turn on/off smart vents in proximity to the smartphone. For example, smart vents can be implemented to determine the relative distance to the smartphone, and those most proximate to the smartphone can open or close, depending on the instructions. The smartphone can retain temperature control at least until the desired temperature is detected by the smartphone's temperature sensor.

At block 406, the electronic device, such as the smartphones 210, 310 and 312 described in FIGS. 2 and 3, can release temperature control, and return temperature control functionality to the smart thermostat, such as the smart thermostats 220 and 320 described in FIGS. 2 and 3, over a communication network, such as the communication network 140 described in FIG. 1. The smartphone can release temperature control automatically, such as when the localized air temperature is within the programmed temperature threshold. Alternatively, a user operating the smartphone can release temperature control via the smart thermostat app residing on the smartphone. The smart thermostat can receive an indication that the temperature control has been released from the smartphone. Temperature control can be returned to the smart thermostat from the smartphone. In some implementations, temperature control can be returned to the smart thermostat via way of instructions from the smart thermostat app residing on the smartphone, or from the network or cloud service associated with the smart thermostat app.

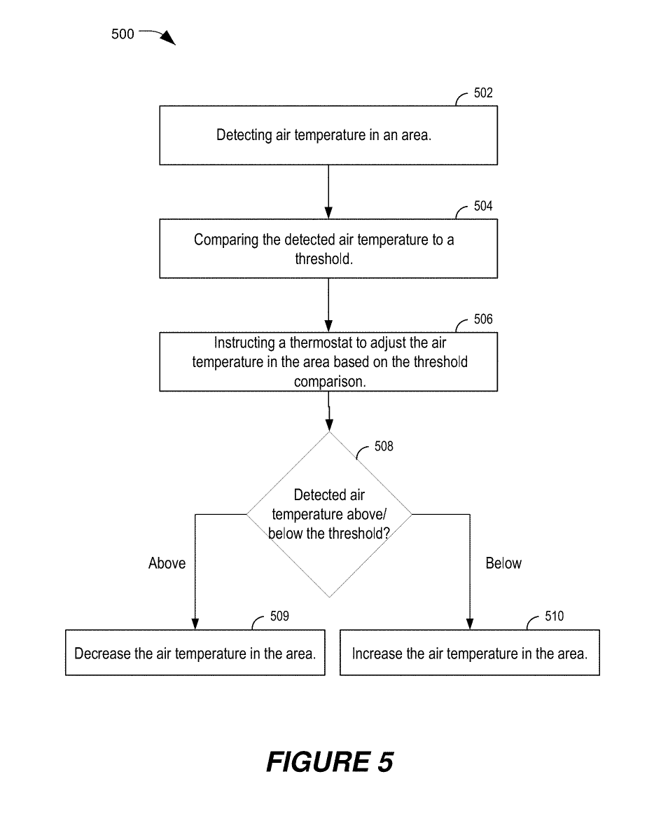

FIG. 5 shows and example method 500 for communicating with an HVAC system. The operations of the method 500 may be implemented by the smartphones 110, 210, 310 and 312, the smart thermostats 120, 220 and 320, and the HVAC systems 130, 230 and 330, depicted and described in FIGS. 1-3, or their components as described throughout.

In some implementations, the described smartphones 110, 210, 310 and 312, the smart thermostats 120, 220 and 320, and the HVAC systems 130, 230 and 330, may execute a set of codes to control the functional elements of the respective device, or of one or more other devices, to perform the functions described in FIG. 5. Additionally, or alternatively, the described smartphones 110, 210, 310 and 312, the smart thermostats 120, 220 and 320, and the HVAC systems 130, 230 and 330, may perform aspects of the functions described in FIG. 5 using special-purpose hardware.

At block 502, air temperature in an area can be detected. The air temperature may be detected by an electronic device. For example, the air temperature may be detected, or sensed, by a temperature sensor built-in, embedded, on an exterior, or other attached to the smartphones 210, 310 and 312, such as the temperature sensors 211, 311 and 313, described in FIGS. 2 and 3. The area may be defined by walls, a floor and a ceiling, such as a room or office, or may be defined in terms of proximity to a particular point, such as a radius from the electronic device.

At block 504, the detected air temperature can be compared to a threshold. The detected air temperature can be compared to a threshold by an electronic device. For example, the detected air temperature may be compared to a temperature threshold by the smartphones 110, 210, 310 and 312, described in FIGS. 1-3. The temperature threshold may include a temperature minimum, a temperature maximum, or a temperature range. The temperature threshold may be preprogrammed, or statically defined, or it may be set dynamically, such as by a user inputting a temperature threshold based on the user's preferences.

At block 506, a thermostat can be instructed to adjust the air temperature in the area based on the threshold comparison. An electronic device can instruct the thermostat to adjust the air temperature in the area based on the threshold comparison. For example, the smartphones 110, 210, 310 and 312, described in FIGS. 1-3 can be implemented to instruct the thermostat to adjust the air temperature in the area based on the threshold comparison. The thermostat can be implemented as a smart thermostat, such as the smart thermostats 220 and 320 described in FIGS. 2 and 3. The thermostat can be connected to an HVAC system, and can control, or otherwise instruct the HVAC system to adjust the air temperature in the area. Adjusting the air temperature includes increasing the temperature or decreasing the temperature. The electronic device can instruct the thermostat to adjust the temperature, and the thermostat can be implemented to initiate one or more HVAC system modules, such as heating, ventilating, or air conditioning, to increase or decrease the temperature. As described throughout, the phrase “based on” does not mean “based only on,” unless expressly specified otherwise. In other words, the phrase “based on” describes both “based only on” and “based at least on.”

At decision block 508, the example method 500 varies, depending on the answer to the question: is the detected air temperature above or below the threshold?

At block 509, the detected air temperature is above the threshold, and as such, the air temperature of the area can be decreased. The electronic device can instruct the thermostat to adjust the temperature, and the thermostat can be implemented to initiate or halt one or more HVAC system modules, such as heating, ventilating, or air conditioning, to decrease the air temperature in the area. For example, and referring to FIGS. 2 and 3, the smartphones 210, 310 and 312 can instruct the smart thermostats 220 and 320 to decrease the air temperature, and in response, the HVAC systems 230 and 330 can be implemented to initiate the air conditioning module, or halt the heating module, or both, until the air temperature in the area has decreased. In some implementations, such as with a smart HVAC system, like smart HVAC system 330, the speed of the air conditioning module can be controlled by the smartphones 210, 310 and 312. In such an implementation, the rate of cooling can be controlled, as well as noise levels generated by the air conditioning module. In some implementations, the air conditioning module will remain initiated, or the heating module will remain halted, or both, until the detected air temperature in the area falls below the threshold.

At block 510, the detected air temperature is below the threshold, and as such, the air temperature of the area can be increased. The electronic device can instruct the thermostat to adjust the temperature, and the thermostat can be implemented to initiate or halt one or more HVAC system modules, such as heating, ventilating, or air conditioning, to decrease the air temperature in the area. For example, and referring to FIGS. 2 and 3, the smartphones 210, 310 and 312 can instruct the smart thermostats 220 and 320 to increase the air temperature, and in response, the HVAC systems 230 and 330 can be implemented to initiate the heating module, or halt the air conditioning module, or both, until the air temperature in the area has increased. In some implementations, such as with a smart HVAC system, like smart HVAC system 330, the speed of the heating module can be controlled by the smartphones 210, 310 and 312. In such an implementation, the rate of warming can be controlled, as well as noise levels generated by the heating module. In some implementations, the heating module will remain initiated, or the air conditioning module will remain halted, or both, until the detected air temperature in the area rises above the threshold.

While the example method 500 in FIG. 5 includes three discrete blocks, a decision block, and two discrete pathways based on the decision block, a person having ordinary skill in the art will readily recognize that other blocks can be inserted between the depicted blocks. Additionally, other blocks may be performed before or after certain depicted blocks.

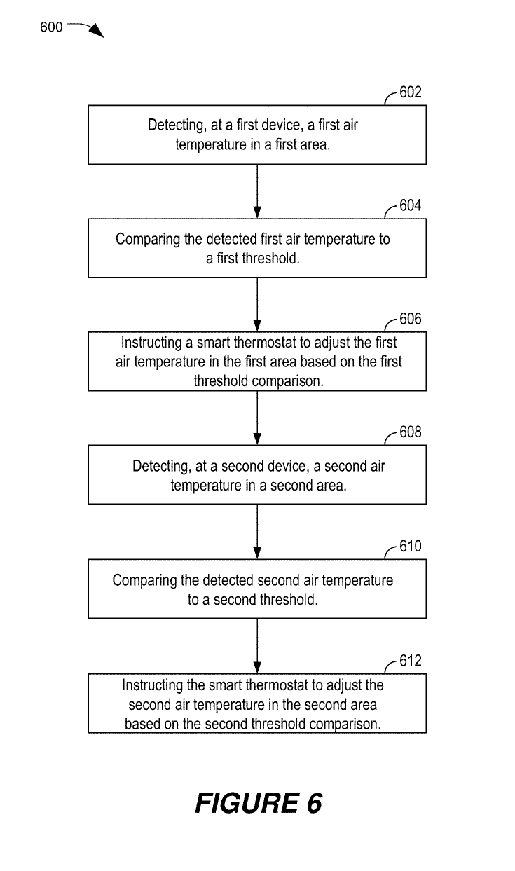

FIG. 6 shows another example method 600 for communicating with an HVAC system. The operations of the method 600 may be implemented by the smartphones 310 and 312, the smart thermostat 320, and the smart HVAC system 330 depicted and described in FIG. 3, or their components as described throughout. In some implementations, the described smartphones 310 and 312, the smart thermostat 320, and the smart HVAC system 330, may execute a set of codes to control the functional elements of the respective device, or of one or more other devices, to perform the functions described in FIG. 6. Additionally, or alternatively, the described smartphones 310 and 312, the smart thermostat 320, and the smart HVAC system 330, may perform aspects of the functions described in FIG. 6 using special-purpose hardware.

A person having ordinary skill in the art will readily recognize that FIG. 5 blocks 502, 504 and 506 are similar to FIG. 6 blocks 602, 604 and 606, respectively. One difference between the Figures is that in FIG. 5, only one air temperature is detected in a particular area, whereas in FIG. 6, first and second air temperatures are detected in first and second areas, respectively. As such, the example method 500 includes a single comparison of the detected air temperature to a temperature threshold, and single instructions to a thermostat to adjust the air temperature in the area based on the threshold comparison, whereas the example method 600 includes two comparisons of the detected air temperature to two different thresholds, and two instructions to a smart thermostat to adjust the air temperature in the two areas based on the two threshold comparisons, respectively.

At block 602, a first air temperature in a first area can be detected at a first device. The first air temperature may be detected by a first electronic device. For example, the first air temperature may be detected, or sensed, by a temperature sensor built-in, embedded, on an exterior, or other attached to the smartphone 310, such as the temperature sensor 311, described in FIG. 3. The first area may be defined by walls, a floor and a ceiling, such as a room or office, or may be defined in terms of proximity to a particular point, such as a radius from the first electronic device.

At block 604, the detected first air temperature can be compared to a first threshold. The detected first air temperature can be compared to a first temperature threshold by the first electronic device. For example, the detected first air temperature may be compared to a first temperature threshold by the smartphone 310 described in FIG. 3. The first temperature threshold may include a temperature minimum, a temperature maximum, or a temperature range. The first temperature threshold may be preprogrammed, or statically defined, or it may be set dynamically, such as by a user inputting a first temperature threshold based on the user's preferences.

At block 606, a smart thermostat can be instructed to adjust the first air temperature in the first area based on the first threshold comparison. The first electronic device can instruct the smart thermostat to adjust the first air temperature in the first area based on the first temperature threshold comparison. For example, the smartphone 310 described in FIG. 3 can be implemented to instruct the smart thermostat, such as the smart thermostat 320 described in FIG. 3, to adjust the first air temperature in the first area based on the first temperature threshold comparison. The smart thermostat can be connected to an HVAC system, and can control, or otherwise instruct the HVAC system to adjust the first air temperature in the first area. In some implementations, the first electronic device can instruct the smart thermostat to adjust the first air temperature, and the smart thermostat can be implemented to initiate or halt one or more HVAC system modules, such as heating, ventilating, or air conditioning, to increase or decrease the temperature accordingly. In some other implementations, such as with a smart HVAC system, like the smart HVAC system 330 described in FIG. 3, the first electronic device can instruct the smart thermostat to adjust the first air temperature, and the smart thermostat can instruct the smart HVAC system to open or close one or more smart vents in the vicinity of the first area, before initiating or halting one or more HVAC system modules. In still some other implementations, the first electronic device can bypass the smart thermostat and directly instruct the smart HVAC system to open or close one or more smart vents located nearby or associated with the first area, before initiating or halting one or more HVAC system modules to adjust the first air temperature in the first area.

At block 608, a second air temperature in a second area can be detected at a second device. The second air temperature may be detected by a second electronic device. For example, the second air temperature may be detected, or sensed, by a temperature sensor built-in, embedded, on an exterior, or other attached to the smartphone 312, such as the temperature sensor 313, described in FIG. 3. The second area may be defined by walls, a floor and a ceiling, such as a room or office, or may be defined in terms of proximity to a particular point, such as a radius from the second electronic device.

At block 610, the detected second air temperature can be compared to a second threshold. The detected second air temperature can be compared to a second temperature threshold by the second electronic device. For example, the detected second air temperature may be compared to a second temperature threshold by the smartphone 312, described in FIG. 3. The second temperature threshold may include a temperature minimum, a temperature maximum, or a temperature range. The second temperature threshold may be preprogrammed, or statically defined, or it may be set dynamically, such as by a user inputting a second temperature threshold based on the user's preferences.

At block 612, the smart thermostat can be instructed to adjust the second air temperature in the second area based on the second threshold comparison. The second electronic device can instruct the smart thermostat to adjust the second air temperature in the second area based on the second temperature threshold comparison. For example, the smartphone 312 described in FIG. 3 can be implemented to instruct the smart thermostat, such as the smart thermostat 320 described in FIG. 3, to adjust the second air temperature in the second area based on the second temperature threshold comparison. The smart thermostat can be connected to an HVAC system, and can control, or otherwise instruct the HVAC system to adjust the second air temperature in the second area. In some implementations, the second electronic device can instruct the smart thermostat to adjust the second air temperature, and the smart thermostat can be implemented to initiate or halt one or more HVAC system modules, such as heating, ventilating, or air conditioning, to increase or decrease the temperature accordingly. In some other implementations, such as with a smart HVAC system, like the smart HVAC system 330 described in FIG. 3, the second electronic device can instruct the smart thermostat to adjust the second air temperature, and the smart thermostat can instruct the smart HVAC system to open or close one or more smart vents in the vicinity of the second area, before initiating or halting one or more HVAC system modules. In still some other implementations, the second electronic device can bypass the smart thermostat and directly instruct the smart HVAC system to open or close one or more smart vents located nearby or associated with the second area, before initiating or halting one or more HVAC system modules to adjust the second air temperature in the second area.

While the example method 600 in FIG. 6 includes six discrete blocks, a person having ordinary skill in the art will readily recognize that other blocks can be inserted between the depicted blocks. Additionally, other blocks may be performed before or after certain depicted blocks. For example, while not depicted in FIG. 6, blocks similar to decision block 508, and blocks 509 and 510 described in FIG. 5, could be implemented with respect to FIG. 6. In other words, if the detected first and/or second air temperatures are above the first and/or second thresholds, respectively, the first and/or second air temperatures of the first and/or second areas, respectively, can be decreased. Conversely, if the detected first and/or second air temperatures are below the first and/or second thresholds, respectively, the first and/or second air temperatures of the first and/or second areas, respectively, can be increased.

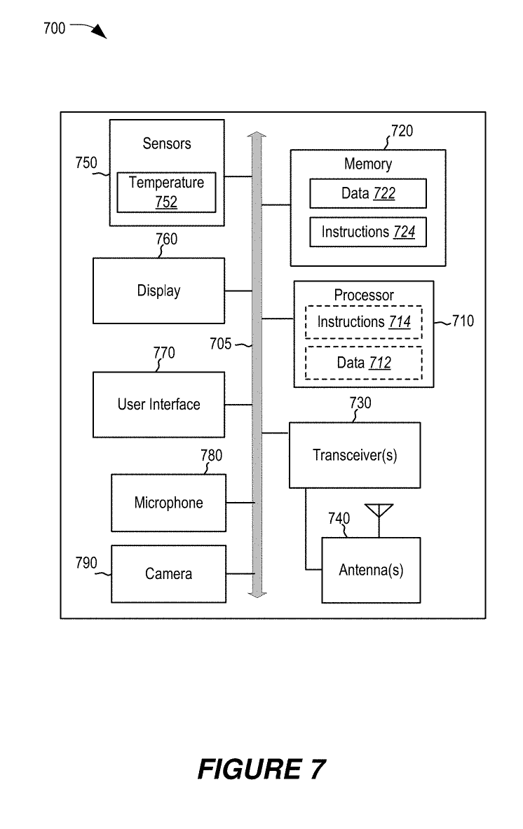

FIG. 7 shows an example electronic device 700 capable of serving as a personal thermostat in communication with an HVAC system. The electronic device 700 may include a wide variety of electronic devices, including any of those discussed above, such as and not limited to the smartphones 110, 210, 310 and 312, depicted in FIGS. 1-3.

The electronic device 700 can include a processor 710, a memory 720, at least one transceiver 730 (i.e., a transmitter and a receiver), and at least one antenna 740. The electronic device 700 also can include one or more sensors 750, a display 760, a user interface (UI) 770 (such as a keypad, touchscreen, voice or gesture interface), a microphone 780 (representative of a microphone and a speaker) and a camera 790. Although not depicted, the electronic device 700 can include one or more network interfaces, such as a wireless network interface (like a cellular interface, a WLAN interface, a Bluetooth® interface, a WiMAX interface, a ZigBee® interface, a Wireless USB interface, etc.) or a wired network interface (like as a powerline communication interface, an Ethernet interface, etc.). In some implementations, the electronic device 700 may support multiple network interfaces, each of which may be configured to couple the electronic device 700 to a different communication network. Each of the components (or “modules”) described with reference to FIG. 7 can communicate with one another, directly or indirectly, over at least one bus 705. The bus 705 may include a power bus, a control signal bus, a status signal bus, a data bus, etc. Example buses 705 can include PCI, ISA, PCI-Express, HyperTransport®, InfiniBand®, NuBus, AHB, AXI, etc.

The processor 710 may be a general-purpose single- or multi-chip microprocessor (such as an Advanced RISC (Reduced Instruction Set Computer) Machine (ARM)), a special purpose microprocessor (such as a digital signal processor (DSP)), a microcontroller, a programmable gate array (such as a field programmable gate array (FPGA)), a shift register, etc. The processor 710 may be referred to as a central processing unit (CPU). Although just a single processor 710 is depicted in the electronic device 700 of FIG. 7, in alternative implementations, a combination of processors (such as an ARM and DSP) including multiple processors, multiple cores, multiple nodes, or implementing multi-threading, etc., can be used.

The electronic device 700 also includes memory 720 in electronic communication with the processor 710 (i.e., the processor can read information from and write information to the memory 720). Memory 720 can be deemed to be in electronic communication with the processor 710 if the processor 710 can read information from or write information to the memory 720. The memory 720 may be any electronic component capable of storing electronic information. The memory 720 may be configured as random-access memory (RAM), read-only memory (ROM), non-volatile random-access memory (NVRAM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 722 and instructions 724 may be stored in the memory 720. The instructions may include one or more programs, routines, sub-routines, functions, procedures, code, etc. The instructions may include a single computer-readable statement or many computer-readable statements. The instructions 724 may be executable by the processor 710 to implement the methods disclosed herein. Executing the instructions 724 may involve the use of the data 722 that is stored in the memory 720. When the processor 710 executes the instructions 724, various portions of the instructions 714 may be loaded onto the processor 710, and various pieces of data 712 may be loaded onto the processor 710.

The memory 720 also can store processor- or computer-executable software code containing instructions that, when executed, cause the processor 710 to perform various functions described herein for optical communication, including reception of a signal, and generation and transmission of an appropriate response signal. The processor 710 also can be implemented to decode received signals and encode response signals.

The processor 710 processes information received through the transceiver 730 as well as information to be sent to the transceiver 730 for transmission through the antenna 740. Additionally, the processor 710 can process information received through one or more sensors 750 as well as information to be presented by the display 760.

In some implementations, the transceiver 730 can be implemented as both a transmitter and a receiver, and can modulate data and provide the modulated data to the antenna 740 for transmission, as well as to demodulate data received from the antenna 740. In some such implementations, the transceiver 730 can be implemented as at least one RF transmitter and at least one separate RF receiver. The transceiver 730 may communicate bi-directionally, via one or more antennas, wired, or wireless communication links as described above. For example, the transceiver 730 may represent a wireless transceiver and may communicate bi-directionally with another wireless transceiver, such as a wireless transceiver associated with the smartphones 110, 210, 310 and 312 depicted in FIGS. 1-3. The transceiver 730 also may include a modem to modulate the packets and provide the modulated packets to the antennas for transmission, and to demodulate packets received from the antennas.

The one or more sensors 750 can include at least one temperature sensor 752. The temperature sensor 752 can be implemented as the temperature sensors 211, 311 and 313 described in FIGS. 2 and 3. The temperature sensor 752 can be embedded, or otherwise fabricated internal to the electronic device 700. Alternatively, or additionally, the temperature sensor 752 can be positioned on the exterior of the electronic device 700. For example, the temperature sensor 752 can be located on or around the bezel of the electronic device 700, such as at the top or a side, or both, of the electronic device 700. In another example, the temperature sensor 752 can be located on the front or back, or both, of the electronic device 700. In some implementations, a first temperature sensor may be located internal to the electronic device 700 and a second temperature sensor may be located external to the electronic device 700.

In situations where a user's hand is in contact, covering, or otherwise adversely affecting the temperature sensor's 752 reading of the localized air temperature, the electronic device 700 can be implemented to prevent requesting temperature control from the smart thermostat, such as the smart thermostats 220 and 320 in FIGS. 2 and 3. Similarly, if the electronic device 700 is inside a user's pants pocket, sports coat or purse, or if the user is using the electronic device 700 in an energy intensive way, such as watching a video or playing a video game on the electronic device 700, or if the electronic device 700 is connected to a wired or wireless charging device, and the temperature sensor's 752 reading of the localized air temperature is adversely affected or inaccurate, the electronic device 700 can be implemented to prevent requesting temperature control from the smart thermostat.

The display 760 can be implemented from any suitable display technology. For example, the display 760 can be implemented from a liquid crystal display (LCD), an e-ink display, a digital microshutter (DMS) display, or an interferometric modulator (IMOD) display. Additionally, the display 760 can be implemented as a flat-panel display, such as plasma, electroluminescent (EL) displays, organic light emitting diode (OLED) display, super twisted nematic (STN) display, or thin-film transistor (TFT) LCD, or a non-flat-panel display, such as a cathode ray tube (CRT) or other tube device. The microphone 780 and the camera 790 allow the electronic device 700 to be suitable for engaging in voice and video communications.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
detecting, at a first device, a first air temperature in a first area;
comparing the detected first air temperature to a first threshold; and
instructing a smart thermostat to adjust the first air temperature in the first area based on the first threshold comparison;
wherein, if the detected first air temperature is above the first threshold, the smart thermostat is configured to decrease the first air temperature in the first area; and
wherein, if the detected first air temperature is below the first threshold, the smart thermostat is configured to increase the first air temperature in the first area.

2. The method of claim 1, wherein the first air temperature is detected using a temperature sensor associated with the first device.

3. The method of claim 2, wherein the first device is one of a smartphone, a mobile device, a laptop computer, a tablet device, a wearable device, an Internet of Things (IoT) device, an Internet of Everything (IoE) device, an IoT hub, or an IoE hub.

4. The method of claim 1, further comprising:
requesting temperature control from the smart thermostat; and
receiving the temperature control.

5. The method of claim 4, wherein the instructing the smart thermostat to adjust the first air temperature in the first area includes turning on or off one or more of a heating, a ventilating and an air conditioning module of an HVAC system.

6. The method of claim 1, further comprising:
detecting, at a second device, a second air temperature in a second area;
comparing the detected second air temperature to a second threshold; and
instructing the smart thermostat to adjust the second air temperature in the second area based on the second threshold comparison.

7. The method of claim 6, wherein:
if the detected second air temperature is above the second threshold, the smart thermostat is configured to decrease the second air temperature in the second area; and
wherein, if the detected second air temperature is below the second threshold, the smart thermostat is configured to increase the second air temperature in the second area.

8. The method of claim 6, wherein the second area is a location different than the first area.

9. The method of claim 6, wherein the adjusted second air temperature is different than the adjusted first air temperature.

10. The method of claim 6, wherein the second device is one of a smartphone, a mobile device, a laptop computer, a tablet device, a wearable device, an Internet of Things (IoT) device, an Internet of Everything (IoE) device, an IoT hub, or an IoE hub, and is different than the first device.

11. An electronic device for wireless communication, comprising:
a temperature sensor;
a network interface;
a processor;
memory in electronic communication with the processor; and
instructions stored in the memory and operable, when executed by the processor, to cause the electronic device to:
detect a first air temperature in a first area;
compare the detected first air temperature to a first threshold; and
instruct a smart thermostat to adjust the first air temperature in the first area based on the first threshold comparison;
wherein, if the detected first air temperature is above the first threshold, the smart thermostat is configured to decrease the first air temperature in the first area; and
wherein, if the detected first air temperature is below the first threshold, the smart thermostat is configured to increase the first air temperature in the first area.

12. The electronic device of claim 11, wherein the processor is further capable of executing processor-executable instructions to:
request temperature control from the smart thermostat; and
receive the temperature control.

13. The electronic device of claim 12, wherein the instructing the smart thermostat to adjust the first air temperature in the first area includes turning on or off one or more of a heating, a ventilating and an air conditioning module of an HVAC system.

14. The electronic device of claim 11, wherein the electronic device is one of a smartphone, a mobile device, a laptop computer, a tablet device, a wearable device, an Internet of Things (IoT) device, an Internet of Everything (IoE) device, an IoT hub, or an IoE hub.

15. The electronic device of claim 11, wherein the processor is further capable of executing processor-executable instructions to:
detect a second air temperature in a second area;
compare the detected second air temperature to a second threshold; and
instruct the smart thermostat to adjust the second air temperature in the second area based on the second threshold comparison;
wherein the second area is a location different from the first area; and
wherein the adjusted second air temperature is different than the adjusted first air temperature.

16. A non-transitory computer-readable medium comprising processor-executable program code configured to cause a processor of an electronic device to:
detect a first air temperature in a first area;
compare the detected first air temperature to a first threshold; and
instruct a smart thermostat to adjust the first air temperature in the first area based on the first threshold comparison;
wherein, if the detected first air temperature is above the first threshold, the smart thermostat is configured to decrease the first air temperature in the first area; and
wherein, if the detected first air temperature is below the first threshold, the smart thermostat is configured to increase the first air temperature in the first area.

17. The non-transitory computer-readable medium of claim 16, wherein the first air temperature is detected using a temperature sensor associated with the electronic device.

18. The non-transitory computer-readable medium of claim 16, wherein the processor is further capable of executing processor-executable program code to cause the electronic device to:
request temperature control from the smart thermostat; and
receive temperature control.

19. The non-transitory computer-readable medium of claim 17, wherein instructing the smart thermostat to adjust the first air temperature in the first area includes turning on or off one or more of a heating, a ventilating and an air conditioning module of an HVAC system.

20. The non-transitory computer-readable medium of claim 16, wherein the processor is further capable of executing processor-executable program code to cause the electronic device to:
monitor the detected first air temperature in the first area; and
send an indication to another electronic device based on the first threshold comparison.
